(19) United States
(12) Patent Application Publication
(10) Pub. No.: US 2026/0301250 A1
(43) Pub. Date: Oct. 1, 2026

(54) SYSTEM AND METHOD FOR PROVENANCE MANAGEMENT OF KNOWLEDGE GRAPH

(71) Applicant: ACCENTURE GLOBAL SOLUTIONS LIMITED, Dublin 4 (IE)

(72) Inventors: Adam Kerry Mills-Campisi, Seattle, WA (US); Ramya Narasimhan, Chennai (IN); Ravi Kiran Velama, Bangalore (IN); Sankar Narayan Das, Barrackpore (IN); Kuntal Dey, Birbhum (IN); Vikrant Kaulgud, Bangalore (IN); Adam Patten Burden, Tampa, FL (US); Kaushik Amar Das, Guwahati (IN)

(73) Assignee: ACCENTURE GLOBAL SOLUTIONS LIMITED, Dublin 4 (IE)

(21) Appl. No.: 19/090,005

(22) Filed: Mar. 25, 2025

(51) Int. Cl. G06T 11/20; G06F 16/901

(52) U.S. Cl. CPC G06T 11/26; G06F 16/9024

(57) ABSTRACT

A system for generating primary graphical representation for the provenance management is disclosed. The system receives a primary graphical dataset, including a prompt, source documents and artifacts from a data sources. The system generates a primary graphical representation including primary entities based on a primary unique identifier associated with the primary graphical dataset. The system generates a plurality of primary time-stamped relations for each of the primary entities by correlating the primary entities with similar pre-determined entities. The system determines an occurrence of an event corresponding to the primary graphical dataset, followed by, generating a plurality of primary hypernodes, event nodes, event-to-event relations, event to entity relations, and/or entity-to-entity relations. The system validates the determined occurrence of the event using Artificial-Intelligence based model and modifies the generated primary entities. Consequently, the system generates an updated graphical representation for the event based on the modification and output on a user interface.

### TECHNICAL FIELD

Various examples described herein relate generally to provenance management of knowledge graph. Specifically, disclosed examples are directed to a system and a method for generating primary graphical representation for the provenance management.

### BACKGROUND

Knowledge Graphs (KGs) are valuable resources that store factual information about specific areas. They are widely used in various fields to organize and extract knowledge from complex datasets. Numerous platforms exist for managing KGs, both in academia and industry. To fully leverage the potential of these KGs, it's crucial to implement robust provenance management. Provenance tracking allows us to understand the origin of the information within the KG. This is vital for building trust, fostering open science practices, and ensuring the reproducibility and updatability of the KG.

Provenance management in the context of KGs refers to the systematic recording and tracking of the origin and evolution of the information contained within the graph. Provenance management enable capturing all modifications made to the KG over time, including additions, deletions, and modifications of entities, relationships, and their associated properties. This allows for understanding the history of the KG and identifying the reasons for any changes.

### SUMMARY

Implementations of the present disclosure are generally directed to provenance management of knowledge graph. More particularly, implementations of the present disclosure are directed to systems and methods for generating primary graphical representation for the provenance management, using generative artificial intelligence (gen AI) and machine learning (ML)

In general, innovative aspects of the subject matter described herein provide a system and a method for provenance management of knowledge graph. The system may include one or more memory configured to store processor-executable instructions and one or more processor communicatively coupled with the one or more memory and configured to execute the processor-executable instructions. The system may receive a primary graphical dataset from a plurality of data sources. The primary graphical dataset may include at least one of a prompt, source documents and a plurality of artifacts. The system may further, generate a primary graphical representation for the received primary graphical dataset. The primary graphical representation may include a plurality of primary entities for the primary graphical dataset based on a primary unique identifier associated with the primary graphical dataset. The system may generate a plurality of primary time-stamped relations for each of the generated plurality of primary entities by correlating the generated plurality of primary entities with similar pre-determined entities. Moreover, the system may determine an occurrence of an event corresponding to the primary graphical dataset based on the generated plurality of primary time-stamped relations. Thereafter, the system may generate at least one of a plurality of primary hypernodes, event nodes, event-to-event relations, event to entity relations, and entity-to-entity relations based on the determined occurrence of the event. Further, the system may validate the determined occurrence of the event along with the plurality of primary hypernodes, the event nodes, the event-to-event relations, the event to entity relations, and the entity-to-entity relations using an Artificial-Intelligence based model. Furthermore, the system may modify the generated plurality of primary entities of the primary graphical representation based on the results of validation. Consequently, the system may generate an updated graphical representation for the event based on the modification and output the updated graphical representation on a user interface of a user device.

The present disclosure further describes a method for implementing the system provided herein. The present disclosure also describes non-transitory computer-readable media (CRM) coupled to one or more processors and having instructions stored thereon which, when executed by the one or more processors, cause the one or more processors to perform operations in accordance with the method described herein.

It is appreciated that systems in accordance with the present disclosure can include any combination of the aspects and features described herein. That is, the system in accordance with the present disclosure are not limited to the combinations of aspects and features specifically described herein, but also include any combination of the provided aspects and features.

The details of one or more implementations of the present disclosure are set forth in the accompanying drawings and the description below. Other features and advantages of the present disclosure will be apparent from the description and drawings, and from the claims.

### DRAWINGS

Various examples in accordance with the present disclosure will be described with reference to the drawings, in which:

FIG. 1 illustrates an example environment used to execute implementations of the present disclosure.

FIG. 2 illustrates an example architecture of a system implementing provenance management of a knowledge graph, in accordance with implementations of the present disclosure.

FIG. 3A-3B illustrates an exemplary implementation of provenance management of the knowledge graph, in conjunction with FIG. 2, in accordance with implementations of the present disclosure.

FIG. 4 illustrates a flow diagram of an example method, to implement provenance management of knowledge graph, in accordance with implementations of the present disclosure.

FIG. 5 illustrates a computer system that may be used to implement the system for implementing provenance management of knowledge graph, in accordance with implementations of the present disclosure

Like reference numbers and designations in the various drawings indicate like elements.

### DETAILED DESCRIPTION

In the following description, various examples will be illustrated by way of example and not by way of limitation in the figures of the accompanying drawings. References to various examples in this disclosure are not necessarily to the same example, and such references mean at least one. While specific implementations and other details are discussed, it is to be understood that this is done for illustrative purposes only. A person skilled in the relevant art will recognize that other components and configurations may be used without departing from the scope of the claimed subject matter.

Reference to any “example” (e.g., “for example”, “an example of”, “by way of example” or the like) are to be considered non-limiting examples regardless of whether expressly stated or not.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any exemplified term. Likewise, the disclosure is not limited to various examples given in this specification.

Without intent to limit the scope of the disclosure, examples of instruments, apparatus, methods, and their related results according to the examples of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

The term “comprising” when utilized means “including, but not necessarily limited to”; it specifically indicates open-ended inclusion or membership in the so-described combination, group, series and the like.

The term “a” means “one or more” unless the context clearly indicates a single element. “First,” “second,” etc., are labels to distinguish components or blocks of otherwise similar names but does not imply any sequence or numerical limitation. “And/or” for two possibilities means either or both of the stated possibilities (“A and/or B” covers A alone, B alone, or both A and B take together), and when present with three or more stated possibilities means any individual possibility alone, all possibilities taken together, or some combination of possibilities that is less than all of the possibilities. The language in the format “at least one of A . . . and N” where A through N are possibilities means “and/or” for the stated possibilities (e.g., at least one A, at least one N, at least one A and at least one N, etc.).

It should also be noted that in some alternative implementations, the functions/acts noted may occur out of the order noted in the figures. For example, two steps disclosed or shown in succession may in fact be executed substantially concurrently or may sometimes be executed in the reverse order, depending upon the functionality/acts involved.

Specific details are provided in the following description to provide a thorough understanding of examples. However, it will be understood by one of ordinary skill in the art that examples may be practiced without these specific details. For example, systems may be shown in block diagrams so as not to obscure the examples in unnecessary detail. In other instances, well-known processes, structures, and techniques may be shown without unnecessary detail in order to avoid obscuring details of the examples.

The specification and drawings are to be regarded in an illustrative rather than a restrictive sense. It will, however, be evident that various modifications and changes may be made thereunto without departing from the broader spirit and scope of the invention as set forth in the claims.

Knowledge Graphs (KGs) represent information in a structured format, facilitating efficient knowledge extraction from diverse sources. However, maintaining high-quality KGs presents significant challenges. The KGs are typically constructed from a multitude of documents. In real-world scenarios, source documents undergo frequent modifications, necessitating continuous updates to corresponding KGs to ensure their accuracy and relevance. Recent advancements in Machine Learning (ML) offer promising solutions for automating KG construction and maintenance. However, the performance of said automated processes is heavily influenced by various factors, including the characteristics of the source documents and the configuration of the ML models. For instance, in LLM-based KG extraction, the prompt engineering and the chosen LLM configuration significantly impact the accuracy of entity identification. Thus, ensuring accountability, transparency, and repeatability is paramount when automating KG construction and maintenance. These principles are crucial for understanding the provenance of information, identifying potential biases, and ensuring the reliability and trustworthiness of the generated KGs.

Modern systems generate massive volumes of data at unprecedented speeds. Using traditional systems, tracking provenance for every piece of data and every transformation is computationally expensive and resource intensive. This leads to performance bottlenecks and scalability issues, especially in real-time or near real-time environments. The traditional system for provenance management is unable in tracking provenance in dynamic environments. That is traditional systems are unable to capture and maintain provenance information dynamically, as the system evolves. The traditional systems basic timestamping to capture changes and relationships between different versions of the KG, leading to limited analysis of data that has been updated.

Therefore, there is a need for a system and method to overcome above-mentioned challenges. The present disclosure, to address the challenges associated with traditional system, disclose a system and a method, which propose a novel provenance hypergraph enabling efficient and effective tracking of the evolution of the knowledge sources and associated artifacts leading to low-overhead tracking of temporal evolution of the KG. The system disclosed in the present disclosure, enable implementation of primary and secondary graphical representation including entities, events, and semantic relations to track the knowledge sources and the related artifacts. Moreover, the system and method disclosed in the present disclosure enable tracking of the events which trigger the modifications of KG. The system and method disclosed in the present disclosure includes creating, managing, and enhancing the entities and the relations of primary graphical representation which tracks the evolution of the knowledge source and associated artifacts of KG. The primary graphical representation is implemented as a complex hypergraph including hypernodes to enrich the knowledge source and maintain the knowledge sources efficiently and effectively. In the present disclosure, the system and method include tracking root-cause events by identifying the events which trigger the modifications of the target KG and enhancing the primary graphical representation by incorporating appropriate entities and the relations. In the present disclosure, the system and method include managing the overhead associated with the primary graphical representation by merging the entities and updating the relations without the compromising the effectiveness of the primary graphical representation. The merging and archiving processes generate multiple hypernodes which represent the primary graphical representation in a compact way.

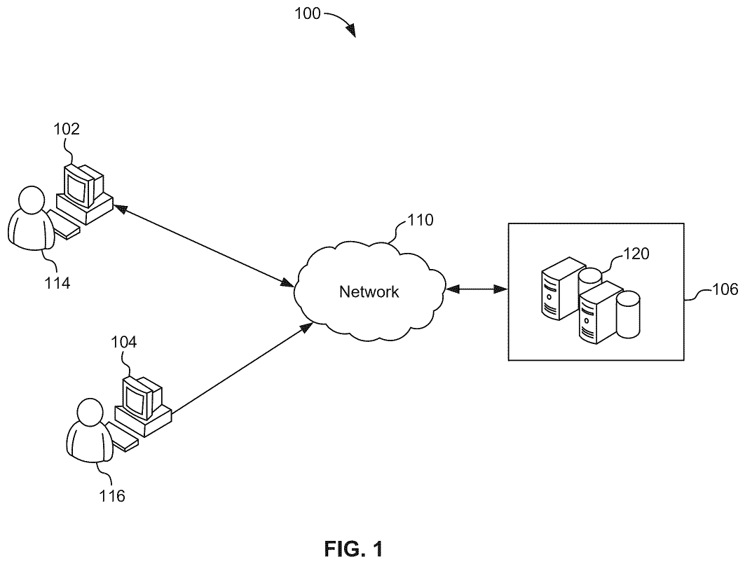

FIG. 1 depicts an example environment 100 that can be used to execute implementations of the present disclosure. In some examples, the example environment 100 enables users associated with respective systems to execute requests to generate content by invoking a trained language model in accordance with implementations of the present disclosure. The example environment 100 includes computing devices 102 and 104, a back-end system 106, and a network 110. In some examples, the computing devices 102 and 104 are used by respective users 114 and 116 to log into and interact with the back-end system 106 and applications executing on the back-end system 106 according to implementations of the present disclosure.

As shown in FIG. 1, the computing devices 102 and 104 are depicted as desktop computing devices. It is contemplated, however, that implementations of the present disclosure can be realized with any appropriate type of computing device (e.g., smartphone, tablet, laptop computer, voice-enabled devices). In some examples, the network 110 includes a local area network (LAN), wide area network (WAN), the Internet, or a combination thereof, and connects web sites (e.g., web applications executing on the back-end system 106), user devices (e.g., the computing devices 102, 104), and the back-end system 106. In some examples, the network 110 can be accessed over a wired and/or a wireless communications link. For example, mobile computing devices, such as smartphones can utilize a cellular network to access the network 110.

While only one back-end system 106 is shown in FIG. 1, there may be more than one back-end system 106, and each of the back-end systems 106 includes at least one server system 120. In some examples, the at least one server system 120 hosts one or more computer implemented services that users can interact with by using the computing devices 102 and/or 104. For example, components of enterprise systems and applications can be hosted on one or more of the back-end system 106. In some examples, the back-end system 106 can be provided as an on-premises system that is operated by an enterprise or a third-party taking part in cross-platform interactions and data management. In some examples, the back-end system 106 can be provided as an off-premises system (e.g., cloud or on-demand) that is operated by an enterprise or a third-party on behalf of an enterprise.

In some examples, the computing devices 102 and 104 each include computer executable applications executed thereon. In some examples, the computing devices 102 and 104 each include a web browser application executed thereon, which can be used to display one or more web pages of applications executing on the back-end system 106. In some examples, each of the computing devices 102 and 104 can display one or more GUIs that enable the respective users 114 and 116 to interact with the back-end system 106. In accordance with implementations of the present disclosure, the back-end system 106 may host enterprise applications or systems that require data sharing and data privacy. In some examples, the computing device 102 and/or the computing device 104 can communicate with the back-end system 106 over the network 110.

In some implementations, the back-end system 106 can be implemented in a cloud environment. The back-end system 106 includes at least one server system (or server) 120. In the example of FIG. 1, the back-end system 106 can include various forms of servers including, but not limited to, a web server, an application server, a proxy server, a network server, and/or a server pool. In general, server systems accept requests for application services and provide such services to any number of client devices (for example, the computing device 102 over the network 110).

In some implementations, the back-end system 106 can be trained, by utilizing artificial intelligence (AI) and a machine learning (ML) technique, to perform qualitative and quantitative analysis of data for the activities under provenance management of the knowledge graph.

Various examples, depicting provenance management of the knowledge graph, are described in detail in conjunctions with figures below.

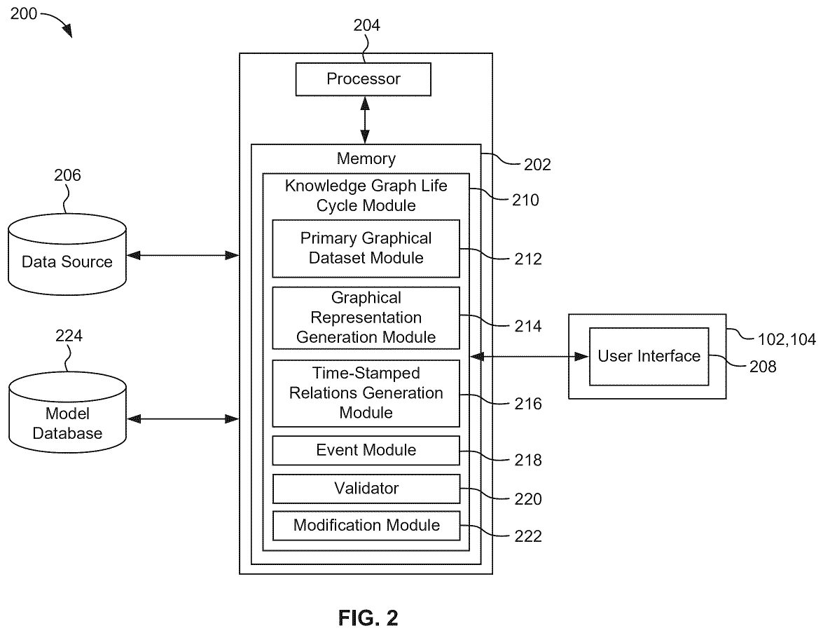

FIG. 2 illustrates an example architecture 200 of the back-end system 106 implementing provenance management of the knowledge graph, in accordance with implementations of the present disclosure. The back-end system 106 may include one or more memory 202 storing processor-executable instructions and the one or more processors 204. The back-end system 106 may be communicably coupled to a plurality of data source 206 and computing device 102, 104, including a user interface 208. The one or more processors 204 may be communicably coupled with the one or more memory 202 and configured to execute the processor-executable instructions. In some examples, the one or more processors 204 may include, but not limited to, microprocessors, microcomputers, hardware processors, microcontrollers, digital signal processors, central processing units, state machines, logic circuits, Application Specific Integrated Circuits (ASICs), Field Programmable Gate Arrays (FPGAs), and/or any devices that manipulate data or signals based on operational instructions. Among other capabilities, the one or more processors 204 may be programmed to cooperate with non-transitory computer-readable instructions stored in the one or more memory 202 (also referred to be as computer-readable medium) for performing operations according to the present disclosure. The one or more memory 202 may be non-transitory or non-volatile medium, such as a magnetic disk or solid-state non-volatile memory or volatile medium such as Random Access Memory (RAM), and/or the like.

In some examples, the one or more memory 202 may include a knowledge graph life cycle module 210. The knowledge graph life cycle module 210 may further include a primary graphical dataset module 212, a graphical representation generation module 214, a time-stamped relations generation module 216, an event module 218, a validator 220 and a modification module 222.

In some examples, the primary graphical dataset module 212 may receive a primary graphical dataset from the plurality of data source 206. The primary graphical dataset may include one or more of a prompt, source documents, a plurality of artifacts and the like. The primary graphical dataset may refer to graphical representation of data stored in the plurality of data source 206. The primary graphical dataset may utilize graph structures for semantic queries with nodes, edges, and properties to represent and store data in the plurality of data source 206. Specifically, entities and the relationships with other entities may be stored as graph structures. The entities may represent the nodes of the graph structure and the edges may represent the relations. There exist standard graph data structure to represent the data as a graph. The plurality of data source 206 may include, but not limited to, databases (for example, relational databases, NoSQL databases, data warehouses), application programming interfaces (API) that provide access to data from other systems or services and files (for example, text files, CSV files, JSON files, image files, or the like). Herein, the prompt may refer to an instruction or query which guides the creation or selection the extraction and representation of knowledge from the primary graphical dataset. For example, the prompt may be “Display sales trends for the past year” or “Visualize the relationships between different products”. The source documents may refer to the original documents or data sources from which the primary graphical dataset is derived. The source documents may include research papers, reports, raw data files, or the like. The artifacts may include, but not limited to, meta-data and annotations. The meta-data may refer to information about the data, such as the source, creation date, author, or the like. The annotations may refer to notes or comments added by users or domain experts, for example “the entity is a subtype of (parent entity)”, “data contains potential biases”, or the like.

Further, the graphical representation generation module 214 may generate a primary graphical representation for the received primary graphical dataset. The primary graphical representation may include a plurality of primary entities for each data point in the primary graphical dataset based on a primary unique identifier associated with the primary graphical dataset. Herein, the primary entities may include one or more nodes and one or more edges. The nodes may refer to individual data points and the edges may represent connections or relationships between the nodes. The primary unique identifier may refer to a unique code or identifier assigned to each primary graphical dataset. The primary unique identifier may serve as a way to uniquely identify and track each data point in primary graphical dataset, thereby, organizing and managing the primary graphical dataset. Specifically, the graphical representation generation module 214 may utilize the primary unique identifier to determine which primary entities to be created for the primary graphical dataset, thereby ensuring correct visual elements may be generated for each unique set of data.

Moreover, to generate the primary graphical representation (by the graphical representation generation module 214) for the received primary graphical dataset, the processor 204 may be configured to extract the metadata associated with the primary graphical dataset using a plurality of learning models. Herein the plurality of learning models may include one or more natural language processing (NLP) models. In other words, the processor 204 may be configured or programmed to extract specific information from the primary graphical dataset. The extracted specific information may be referred to as meta-data. The meta-data may provide information about the primary graphical dataset. The non-limiting examples of the meta-data may include source of the data, creation date and time, data format (for example, CSV, JSON, XML), data quality and data description. Herein, the source of the data may refer to information about the origin of data (for example, a specific database, research paper, sensor, or the like). The data quality may refer to the information about the accuracy, completeness, and reliability of the data. The data description may refer to textual description of the data, the purpose, and the intended use.

Moreover, the graphical representation generation module 214 may communicate with a model database 224, said model database 224 may include the plurality of learning models. Specifically, the model database 224 may include one or more Large Language Models (LLMs) (also be referenced to as Generative Artificial Intelligence (GAI)) models, foundation models, natural language processing (NLP) models and/or the like). In an implementation, the LLMs may include pre-trained LLMs or generated LLMs. The pre-trained LLMs may be general-purpose GAI models like large deep learning neural networks, which may be trained using a broad range of generalized and unlabeled training data to perform one or more tasks, such as, human computer interactions (i.e., question and answering), automating process execution, process planning, generating step-by-step procedures for the process execution, performing data analysis, and/or the like. While implementations of the present disclosure are described in further detail herein with non-limiting reference to the LLMs, it is contemplated that implementations of the present disclosure may be realized using any appropriate foundation models or Machine Learning (ML) models, or Artificial Intelligence (AI) models.

In an example, to extract the meta-data associated with the primary graphical dataset, the graphical representation generation module 214 may utilize the NLP models to identify relevant data sources, that is, determine the parts of the primary graphical dataset containing potential meta-data. For instance, each document (in the data sources) may include a title and description a topic or a list of topics. Herein, NLP may identify the title and/or most relevant topic(s). The identified title and/or most relevant topic(s) may be used as metadata. Further, each document may have unique ID, which may be used as metadata.

Furthermore, the graphical representation generation module 214 may perform data cleaning and preprocessing. The data cleaning may include removing of irrelevant characters (for example, punctuation, special characters, or the like), converting text to lowercase, and removing inconsistencies in spelling and capitalization. The preprocessing may include normalization. The normalization may further include applying techniques such as, stemming (reducing words to their root form) and lemmatization (converting words to their dictionary form) to improve the accuracy of NLP models. Additionally, the preprocessing may include generating new features from the existing data, such as word counts, TF-IDF scores (term frequency-inverse document frequency), and sentiment scores. The new features may facilitate further processing by the graphical representation generation module 214.

Thereafter, the graphical representation generation module 214 may select one or more NLP models based on the specific meta-data extraction. For example, the named entity recognition (NER) models may be selected to identify and classify named entities (for example, people, organizations, locations, dates, or the like) within the text. The part-of-speech (POS) tagging models may be selected to identify the grammatical role of each word in a sentence (for example, noun, verb, adjective, or the like). The sentiment analysis models may be selected to determine the overall sentiment or emotion expressed in the text. The topic modeling models (for example, latent dirichlet allocation (LDA), latent semantic analysis (LSA)) may be selected to identify the main topics or themes described in the text. After that the selected models may be trained on a suitable training dataset. The training may include feeding the selected models with labeled data (where the correct meta-data is already known) and enabling the selected models to learn patterns and relationships between the data and the desired output. Furthermore, the trained models may be applied to the preprocessed text data extracted from the primary graphical dataset. Based on the model outputs, the graphical representation generation module 214 may extract the relevant meta-data features and combine the extracted features from the selected models into a comprehensive set of meta-data. For example, the primary graphical dataset may be a knowledge graph representing a social network of researchers, including nodes for researchers, affiliations, and publications. The extracted preprocessed text data may be a collection of research papers authored by the researchers in said social network of researchers, extracted from a research repository. The named entity recognition (NER) model may be trained and applied to identify and classify named entities (e.g., researchers, organizations, journals) within the research papers. The NER model may output list of researchers, organizations, and journals identified within each research paper. Further, sentiment analysis model may be trained and applied to analyze the sentiment expressed in the research papers (e.g., positive, negative, neutral). The sentiment analysis model may output sentiment scores for each research paper (e.g., sentiment polarity, sentiment intensity). The extracted features from the NER model and sentiment analysis model may be combined into a comprehensive set of meta-data for each research paper. The combined meta-data may then be used to enrich the primary graphical dataset by adding new attributes to researcher nodes (e.g., “research interests,” “sentiment scores of publications”), creating new relationships between researchers based on shared research topics or collaborations and/or identifying influential researchers based on the sentiment and impact of their publications.

Moreover, based on the extracted meta-data, the graphical representation generation module 214 may generate a template including a plurality of attributes. The plurality of attributes may include one or more of an unique identifier of an entity, a title of the entity, a type of the entity, a location of the entity, an owner of the entity, a source uniform resource locator (URL) of the entity, a version number of the entity, and an inclusion time of the entity. Herein, the entity may refer to object or concept that is represented within the the primary graphical representation. The template may refer to a structured framework or schema which defines the attributes or properties of the entities within the primary graphical dataset. The template may ensure consistency and uniformity in how entities are represented and visualized. Further, the plurality of attributes may represent properties of each entity, providing detailed representation of the entity and associated characteristics. For instance, unique identifier of the entity may refer to a unique code or ID assigned to each entity to distinguish said entity from other entities, for example, “Entity_123”, “Product_ID_456”, or the like. The title of the entity may refer to descriptive name for the entity, for example, “Company A”, “Research Paper on AI”, “Sensor Data”. The type of the entity may refer to the category (for example, person, organization, document, event, or the like). The location of the entity may refer to physical or geographical location associated with the entity, for example, “New York”, “USA”, “Latitude/Longitude Coordinates”, or the like. The owner of the entity may refer to the individual or organization which owns or is responsible for the entity, for example, “John Doe”, “University of X”, or the like. The source URL may refer to the URL of the source document or website from where information about the entity was obtained. The version number of the entity may indicate the current version of the entity's information, for example, “v1.0”, “v2.2”. The inclusion time of the entity may indicate when the entity was included in the primary graphical dataset.

Moreover, to generate the template comprising the plurality of attributes, the graphical representation generation module 214 may compare the extracted meta-data with a set of meta data pre-stored in a database (not shown in FIG. 2), using the plurality of learning models. The comparison may include, but not limited to attribute matching and pattern matching. The attribute matching may include comparing the extracted meta-data attributes (for example, keywords, entities, sentiment, or the like) with the attributes defined in the pre-stored meta-data definitions. The pattern matching may include identifying patterns and relationships within the extracted meta-data that match known patterns associated with specific types of data. The plurality of learning models may include, but not limited to, text classification models, entity recognition models and topic modeling models. The text classification models may classify the text data associated with the “primary graphical dataset” into different categories (for example, news articles, scientific papers, financial reports, or the like). The entity recognition models may identify and classify named entities within the text data, which may provide information of the data type. The topic modeling models may identify the main topics or themes described within the text data, which may categorize the data.

The graphical representation generation module 214 may determine a specific type of data associated with the primary graphical dataset, based on the comparison. The specific type of data may correspond to a real-time meta-data comprising specific data properties. The real-time meta-data may refer to data which may be dynamically generated or updated in real-time, reflecting the current state and characteristics of the data. The specific data properties may refer to unique characteristics or properties which define the specific type of data. For example, news articles may have specific properties like publication date, author, source, and keywords. In another example, financial data may have properties like “stock symbol,” “trading volume,” “price,” and “date”. In further detail, the real-time meta-data may be generated and updated through continuous monitoring and analysis of the underlying data. Techniques such as data streaming, change data capture, and real-time analytics may be utilized to capture and process data changes in real-time. For instance, data streaming may be utilized for high-velocity data streams (for example, sensor data, financial market data, social media feeds, or the like), thereby, continuously ingesting and processing incoming data streams, extracting relevant features and generating real-time meta-data. The change data capture techniques may capture and track changes to data within primary graphical dataset. The changes may include insertions, updates, and deletions of records. The change data capture techniques may provide a continuous stream of information about data modifications, enabling real-time updates to the associated meta-data. The real-time analytics may include techniques such as, apache kafka, apache spark streaming, and flink to process data streams in real-time. The data streams mat be divided into time windows (e.g., 1-second, 1-minute intervals) for analysis. Real-time aggregations (e.g., counts, averages, sums) may be computed within said time windows to generate summary statistics and other relevant meta-data. Moreover, real-time anomaly detection techniques may identify unusual patterns or deviations from expected behavior in the data stream. The anomalies may be flagged as important meta-data, triggering alerts or further investigation.

Further, the graphical representation generation module 214 may create the primary unique identifier for each of the plurality of primary entities of the primary graphical dataset, based on the determined specific type of data. For example, for news articles, the unique identifier may be generated using a combination of the article title, publication date, and source. In another example, for financial data, the unique identifier may be generated using the stock symbol and the date of the data. Consequently, the graphical representation generation module 214 may generate the template comprising the plurality of attributes, for the plurality of primary entities of the primary graphical dataset, based on the created primary unique identifier. In essence, template may be utilized to design/structure each entity. An example of template may be entity_template: <unique identifier, title if any, type of entity, stored location, owner, source url, version number, time of inclusion>.

Furthermore, the graphical representation generation module 214 may generate the primary graphical representation for the received primary graphical dataset, based on the generated template. Specifically, the graphical representation generation module 214 may iterate through each entity within the primary graphical dataset. For each entity, the graphical representation generation module 214 may map the entity's attributes to the corresponding fields defined in the generated template, thereby, ensuring that the data for each entity may be organized and structured according to the template's specifications. Moreover, based on the criteria specified in the template (for example, entity type, location, time range), the graphical representation generation module 214 may select the relevant entities for inclusion in the primary graphical representation. In an example, filtering mechanisms may be implemented to exclude irrelevant or redundant entities. Specifically, said filtering mechanisms may include NLP techniques. By using NLP techniques, such as stemming, lemmatization, and term frequency-inverse document frequency (TF-IDF) score, the relevancy and/or uniqueness of the entity may be determined. Further, the uniqueness of the entity may be determined by NLP string-matching technique(s).

After that the graphical representation generation module 214 may assigns visual encodings to the selected entities based on their attributes. Visual encodings may refer to techniques used to map data attributes to visual properties in a way that effectively represent information. The Visual encodings may be essential for creating clear, informative, and insightful visualizations. For example, position encoding may be assigned using spatial positions (for example, x-y coordinates) to represent relationships between entities or their locations. After that, the graphical representation generation module 214 may determine the layout and composition of the visualization and the relationships between entities. In other words, nodes may be arranged in a hierarchical structure based on the relationships. Additionally, the graphical representation generation module 214 may render the visualization using a suitable visualization library or framework (for example, D3.js, Plotly, Bokeh, or the like).

Furthermore, the time-stamped relations generation module 216 may generate a plurality of primary time-stamped relations for each of the generated plurality of primary entities by correlating the generated plurality of primary entities with similar pre-determined entities. Specifically, the primary time-stamped relations may refer to relations between entities over time. The time-stamped relations generation module 216 may compare the generated entities with a set of pre-defined entities which may exist within the knowledge graph life cycle module 210. The comparison may identify similarities or correspondences between the newly generated entities and the existing entities by utilizing techniques like, but not limited to, attribute matching, semantic similarity and machine learning (ML). The attribute matching may refer to comparing attributes such as name, type, location, and other relevant properties. The semantic similarity may include using techniques like natural language processing (NLP) to determine semantic similarity between entity descriptions. The ML techniques may include training ML models to identify and classify relationships between entities. To train the ML model, a plurality of dataset may be created where each data point may include two entities, label indicating the relationship between the entities (or “no relationship”) and features describing the entities and corresponding context. Following, features may be extracted from the data points, such as, entity attributes (e.g., names, types, properties), textual context (e.g., sentences or paragraphs containing the entities), graph-based features (e.g., paths between entities in the knowledge graph) and word embeddings. The ML models may be trained on the created dataset. The ML models may learn to associate the extracted features with the corresponding relationship labels, by using techniques, such as, supervised learning techniques. Additionally, trained ML model's performance may be evaluated on a separate test dataset. The metrics like accuracy, precision, recall, and F1-score may be used to assess the ML model's capability to correctly identify and classify relationships. The trained model may be deployed to identify and classify relationships between entities.

In further detail, each relation may include a plurality of attributes to indicate the time-stamp. The time-stamps may be used to estimate which relations precede whom. The relations may be ordered based on the time-stamps and a history of the events may be created to identify the changes in the entities and the relations. Additionally, root-causes of the event may also be identified. Thereafter, based on the comparison results, the time-stamped relations generation module 216 may identify a time stamp data of the plurality of primary entities, based on the plurality of attributes. Specifically, the time-stamped relations generation module 216 may determines the specific timestamp associated with each entity. The time stamp data may represent a significant event or point in time related to the entity's existence or its relationship with other entities.

In further detail, the time-stamped relations generation module 216 may identify the time stamp data of a plurality of external entities. The time stamp data of the plurality of external entities correspond to an inclusion time of the plurality of external entities. The plurality of external entities may refer to entities which may originate from the data source 206, for example, external databases, APIs, or other external systems. The inclusion time may refer to the specific point in time when the external entity was first included or integrated into the primary graphical dataset. The inclusion time may provide information about the origin and history of external entities. The inclusion time may, further, track when said external entities are first incorporated into the primary graphical dataset and provides context for the presence within the data. Specifically, time-stamp data may detect of discrete events, which may serve as change indicators within the primary graphical dataset. The resulting event chain may establish a provenance record, detailing the temporal dependencies and causal factors behind dataset modifications. Moreover, the time-stamped relations generation module 216 may determine a plurality of external relations between the plurality of primary entities associated with the primary graphical dataset, and the plurality of external entities, using the plurality of learning models, based on the identified time stamp data of the plurality of external entities. The plurality of external entities may correspond to target knowledge graphs (KGs). The plurality of external entities may refer to entities extracted from external knowledge bases or ontologies. The non-limiting examples may include entities from Wikidata, DBpedia, or other publicly available KGs. The target KGs may refer to specific external knowledge bases or ontologies from which the external entities may be extracted sourced. The plurality of external relations may include relations, for example, equivalence, subsumption, association or the like. The equivalence may imply identifying instances where the primary entity is equivalent to the external entity from the target KG. The subsumption may imply identifying instances where the primary entity is a sub-type or a specialization of the external entity. The association may imply identifying instances where the primary entity is associated with the external entity in certain way (for example, has a related concept, is located in the same region). Consequently, the time-stamped relations generation module 216 may generate a plurality of external time-stamped relations for each of the generated plurality of primary entities, based on the determined plurality of external relations. Specifically, the plurality of external time-stamped relations may refer to temporal relationships connecting primary entities within the primary graphical dataset to external entities from target KGs. The plurality of external time-stamped relations may be explicitly associated with timestamps to indicate their validity or relevance over time. The generation of plurality of external time-stamped relations may include assigning timestamps to each external relation based on the inclusion time of the associated external entity and other relevant temporal information.

Moreover, generation of plurality of external time-stamped relations may include applying temporal filters to the external relations to ensure that only relevant and up-to-date relationships are considered. For example, filtering out relationships based on the inclusion time of the external entity if it is older than a certain threshold. Additionally, using temporal reasoning techniques, the time-stamped relations generation module 216 may infer the validity or relevance of external relations over time. For example, if the inclusion time of the external entity is older than the last update to the primary graphical dataset, the corresponding external relation may be considered less reliable. In an example, the external time-stamped relations may be “Equivalent (2023 Nov. 15)”, indicating that the primary entity is equivalent to the external entity as of Nov. 15, 2023. In essence, the external time-stamped relations may enable the knowledge graph life cycle module 210 to track changes in the relationships between entities as new data is integrated and the knowledge graph evolves.

Moreover, the time-stamped relations generation module 216 may determine a plurality of internal relations between the plurality of primary entities associated with the primary graphical dataset and the pre-determined entities, based on the identified time stamp data of the plurality of primary entities. The time-stamped relations generation module 216 may utilize the plurality of learning models, to identify said internal relationships. The relations may include, but not limited to, equivalence, subsumption and association. Herein, the equivalence may include identifying instances where the generated entity is equivalent to an existing pre-defined entity. The subsumption may include identifying instances where the generated entity is a sub-type or a specialization of an existing entity. The association may include identifying instances where the generated entity is associated with an existing entity in a specific way. In further detail, said learning models may perform entity resolution to identify matching entities between the primary graphical dataset and the pre-determined entities. The entity resolution may further include string matching, attribute comparison and semantic similarity. The string matching may refer to comparing entity names and labels using techniques like fuzzy matching, Levenshtein distance, or Jaro-Winkler distance. The attribute comparison may refer to comparing entity attributes (e.g., types, properties, descriptions). The semantic similarity may refer to using techniques like word embeddings or knowledge graph embeddings to assess the semantic similarity between entities. Once matching entities are identified, the time-stamped relations generation module 216 may create links or relationships between the plurality of primary entities associated with the primary graphical dataset and the pre-determined entities.

Thereafter, the time-stamped relations generation module 216 may generate the plurality of primary time-stamped relations for each of the generated plurality of primary entities, based on the determined plurality of internal relations. Specifically, for each identified internal relation, the time-stamped relations generation module 216 may assign the timestamp. The timestamp may represent when the relationship between the entities was established or when a specific event related to the relationship occurred. In other words, the timestamp may represent the time of creation of the generated entity, the time when the relationship between the entities was first established and the time of the last update to the relationship. In essence, the time-stamped relations generation module 216 may establish and maintain a dynamic understanding of the relationships between entities within the knowledge graph life cycle module 210. By correlating generated entities with pre-defined entities and assigning timestamps to said relations, the time-stamped relations generation module 216 may provide insights into the temporal evolution of the data.

Moreover, the event module 218 may determine an occurrence of an event corresponding to the primary graphical dataset based on the generated plurality of primary time-stamped relations (by the time-stamped relations generation module 216). In further detail, the event module 218 may identify and characterize events based on the temporal relationships between entities by analyzing the generated time-stamped relations to identify patterns or sequences that indicate the occurrence of specific events. In an example, said analysis to identify patterns or sequences may include sequence analysis, temporal logic and ML. The sequence analysis may refer to identifying specific orders or sequences of events. The temporal logic may include applying formal temporal logic to define and detect event occurrences. The ML may include training ML models to recognize patterns in the temporal data that correspond to specific events. Based on the identified patterns, the event module 218 may define the characteristics of the event. For instance, the event module 218 may assigning a label or category to the event (for example, “product launch,” “customer churn,” “project completion”, or the like). In another instance, the event module 218 may identify the entities involved in the event and determining the time of the event based on the timestamps of the related entities. Additionally, the event module 218 may represents the identified event in a suitable format. For example, the event module 218 may generate a new event object with own set of attributes (type, time, participants, or the like.). In another example, the event module 218 may add the event information to the existing data structures.

Additionally, the event module 218 may generate a plurality of primary hypernodes, event nodes, event-to-event relations, event to entity relations, and/or entity-to-entity relations based on the determined occurrence of the event. Herein, the primary hypernode may represent complex entities or concepts that encompass multiple other entities and their relationships. The primary hypernode may provide a higher-level abstraction of the underlying data. For example, the primary hypernode “organization” may represent the entire company, including departments, employees, and projects. The event nodes may represent specific events detected by the event module 218, for example, “Product Launch,” “Project Milestone Reached,” “Customer Complaint Received”. The event-to-event relations may represent relationships between different events, for example, “precedes” (event A precedes event B), “causes” (event A causes event B), “overlaps” (events A and B occur concurrently). The event-to-entity relations may represent relationships between events and entities, for example, “triggered by” (event A was triggered by entity X), “affects” (Event A affects Entity Y). The entity-to-entity relations may represent relationships between entities which are inferred or strengthened based on the detected events, for example, “collaborated on” (entity A and entity B collaborated on a project based on the sequence of events).

Furthermore, to generate one or more of the plurality of primary hypernodes, the event nodes, the event to event relations, the event to entity relations, and the entity-to-entity relations based on the determined occurrence of the event, by the event module 218, the processor 204 may be configured to determine the occurrence of the event by identifying a triggering operation of the event. Herein, the triggering action may refer refers to an action or event that initiates the occurrence of another event. The triggering action may be specific changes or modifications made to the underlying data. The triggering operation of the event may include a modification of the primary graphical dataset, an upgrade of the primary graphical dataset, a deletion of the primary graphical dataset, a modification of the primary graphical dataset, and/or a modification of the plurality of artifacts. Specifically, the modification of the primary graphical dataset may include changes to the data within said primary graphical dataset, such as adding, deleting, or updating entities, attributes, or relationships. The upgrade of the primary graphical dataset may include updating the primary graphical dataset with new versions of data from the data source 206, incorporating new data sources into the primary graphical dataset and/or upgrading the underlying data model or schema. The deletion of the primary graphical dataset may include completely or partially removing the primary graphical dataset from the system. The modification of the plurality of artifacts may include adding, modifying, or deleting associated documents, annotations, or other artifacts related to the primary graphical dataset. Additionally, each modification of the primary graphical dataset may generate metadata. The generated metadata may also be represented as graph and the properties of said graph may be used to determine the occurrence of specific event, such as number of outgoing edges with different time-stamps from event-node may provide the number of occurrence of the specific event.

Moreover, to generate one or more of the plurality of primary hypernodes, the event nodes, the event to event relations, the event to entity relations, and the entity-to-entity relations based on the determined occurrence of the event, by the event module 218, the processor 204 may be configured to determine a plurality of attributes associated with an event template. The plurality of attributes may include the triggering operation of the event, a successor identifier (ID) of the event, a predecessor ID of the event, an artifact list of the event, and/or a time of the event. Specifically, the triggering operation of the event captures the specific action or event that triggered the occurrence of the current event. The successor identifier (ID) of the event may refer to the identifier (ID) of the event(s) that directly follow the current event in a sequence or chain of events. The predecessor ID of the event may refer to the identifier (ID) of the event(s) which directly precede the current event in a sequence or chain of events. The artifact list of the event may refer to list of artifacts (for example, documents, images, data files, or the like) which are associated with the event. The artifacts may provide additional context or evidence related to the event. The time of the event may refer to the timestamp associated with the occurrence of the event. For instance, said timestamp may include the start time, end time, or a specific point in time within the event's duration. Consequently, the event module 218 may generate the plurality of primary hypernodes, the event nodes, the event-to-event relations, the event to entity relations, and/or the entity-to-entity relations based on the determined plurality of attributes associated with the event template.

In further detail, the knowledge graph life cycle module 210 may generate said event templates. The knowledge graph life cycle module 210 may compare the extracted meta-data with a set of meta data pre-stored in a database, using the plurality of learning models.

In an example, the time of the event (of the plurality of attributes) may directly influence the creation of event nodes by determining the temporal placement within the graph. Furthermore, the triggering operation of the event attribute may be used to categorize and label event nodes, providing context for the event occurrence. The artifact list attribute may be used to create hypernodes encompassing all entities and events related to a specific artifact or set of artifacts. The successor ID and predecessor ID attributes may be used to create hypernodes that represent groups of events or entities which are sequentially linked. Additionally, the successor ID and predecessor ID attributes may directly define event-to-event relationships, establishing temporal sequences and causal links between events. By analyzing the relationships between events which involve specific entities, the event module 218 may infer new entity-to-entity relationships. For example, if two entities are frequently involved in the same events, the event module 218 may infer a “collaboration” or “association” relationship between said events. In further detail, the event module 218 may implement rule-based frameworks to define how specific attribute combinations lead to the creation of particular nodes and relationships. For example, if the triggering operation is “Entity Modification” and the artifact list includes a specific document, the event module 218 may create an “Entity-to-Artifact” relationship. In another example, if the successor ID of one event matches the predecessor ID of another event, the event module may create a “Precedes” relationship between said events. In an aspect, ML models may be trained to learn patterns and relationships between event attributes and the corresponding graph structures. The trained ML models may be then used to predict and generate new nodes and relationships based on the observed patterns.

In another aspect, to determine the occurrence of the event (by event module 218) by identifying the triggering operation of the event, the processor 204 may cause the event module 218 to identify a root cause of the event. The root cause of the event may refer to the fundamental underlying factor which initiates the event. In other words, the root cause may be the core reason for the event's occurrence. Herein, the root cause of the event may include the modification of the primary graphical dataset, the upgrade of the primary graphical dataset, the deletion of the primary graphical dataset, the modification of the primary graphical dataset, and/or the modification of the plurality of artifacts. After identifying the root cause, the event module 218 may determine changes in the primary graphical dataset, based on the identified root cause event. For instance, the event module 218 may utilizing version control systems to track changes to the primary graphical dataset over time, maintain logs of all modifications made to the primary graphical dataset and compare the state of the primary graphical dataset before and after the root cause event to identify specific changes. Consequently, the event module 218 may analyze the determined changes in the primary graphical dataset to correlate them with the expected outcomes of the identified root cause event, thereby, determine the occurrence of the event, based on the determined changes. For example, if the root cause is the “modification of the primary graphical dataset” and the observed changes include the addition of a new entity representing a new product, the event module 218 may determine that the event “New Product Introduced” has occurred.

Following, the validator 220 may validate the determined occurrence of the event along with the plurality of primary hypernodes, the event nodes, the event-to-event relations, the event to entity relations, and the entity-to-entity relations using Artificial-Intelligence (AI) based model. Specifically, the validator 220 may assessing and validate the accuracy and reliability of the detected event and the generated primary graphical representation. The AI based model may include, but not limited to, ML models, deep learning models and knowledge graph embeddings. The ML models, such as supervised learning models (for example, classification, regression) may be trained on labeled data to predict the correctness of event detections and the accuracy of generated primary graphical representation elements. The deep learning models, such as neural networks, may be trained on complex patterns and relationships within the data to improve validation accuracy. The knowledge graph embeddings represent entities and relationships as vectors in a continuous space, allowing for more accurate similarity comparisons and anomaly detection.

In further detail, the validator 220 may receive historical data on event occurrences, generated graph structures, and associated meta-data. The received data may be then, cleaned, preprocessed, and labeled with ground truth information (that is, whether the event detection and primary graphical representation generation were correct). The AI based model may be trained on the prepared data to learn patterns and relationships between event characteristics (for example, triggering operations, timestamps, associated artifacts, or the like), graph features (for example, number of nodes, number of relationships, types of relationships, topological properties of the graph) and ground truth information. The trained AI based model may be used to evaluate the accuracy of newly detected events and generated primary graphical representation. In other words, the validator 220 may validate the correctness of the event type and its associated attributes. Further the validator 220 may validate the accuracy of the generated nodes, properties and established relationships between nodes. The results of the validation are analyzed to identify areas for improvement in the event detection and primary graphical representation generation processes. Additionally, the AI based model may be further trained or refined based on the results of the validation from the validator 220.

Moreover, based on the results of validation from the validator 220, the modification module 222 may modify the generated plurality of primary entities of the primary graphical representation. The modification module 222 may receive a secondary graphical dataset from the plurality of data sources. The secondary graphical dataset may include new entities other than previously included in the primary graphical dataset. Moreover, the secondary graphical dataset may include changes to the properties of existing entities and/or new connections between entities of the primary graphical dataset. Additionally, said secondary graphical dataset may include corrections to errors or inaccuracies in the data present in primary graphical dataset. Furthermore, the secondary graphical dataset may correspond to an updated version of the primary graphical dataset. In other words, secondary graphical dataset may include the latest state of the data, incorporating any changes or updates that have occurred since the creation of the primary graphical dataset. For example, the validator 220 may validate the uniqueness of the entity. If the entity is unique, the modification module 222 may create a new node else the modification module 222 may update the pre-existing primary graphical dataset with appropriate modifications.

Thereafter, the modification module 222 may generate a secondary graphical representation for the received secondary graphical dataset. Herein, the secondary graphical representation may include a plurality of secondary entities for each of the secondary graphical dataset based on a secondary unique identifier associated with the secondary graphical dataset. Specifically, the plurality of secondary entities may include new and/or updated entities. The new entities may refer to the entities other than present in the primary graphical dataset and the updated entities may refer to the existing entities of the primary graphical dataset with modified attributes or relationships. The secondary unique identifier may include unique code or identifier assigned to each secondary graphical dataset. The secondary unique identifier may uniquely identify and track each version and corresponding graphical representation. Furthermore, the modification module 222 may generate a plurality of secondary time-stamped relations between the primary graphical dataset and the secondary graphical datasets by correlating the generated plurality of primary entities with the generated plurality of secondary entities.

Furthermore, the modification module 222 may generate a plurality of secondary time-stamped relations between the primary graphical dataset and the secondary graphical datasets by correlating the generated plurality of primary entities with the generated plurality of secondary entities. The plurality of secondary time-stamped relations may connect entities in the primary graphical dataset with their corresponding entities in the secondary graphical datasets, thereby, indicating when the changes occurred. Further, the correlation of the generated plurality of primary entities with the generated plurality of secondary entities by the modification module 222 may include identifying and matching entities between the primary graphical dataset and the secondary graphical datasets. For instance, the modification module 222 may implement techniques such as entity matching and attribute comparison. Herein, the entity matching may include record linkage, entity resolution, and fuzzy matching, which may be used to identify and link entities across different datasets (that is, the primary graphical dataset and the secondary graphical datasets), even if corresponding identifiers or attributes differ. The attribute comparison may refer to comparing attributes such as name, type, location, and other relevant properties to determine entity correspondence. In essence, the secondary graphical representation may provide a visual representation of the updated data, allowing users to observe and understand the changes that have occurred since the secondary graphical representation data was visualized.

In further detail, the modification module 222 may generate a plurality of secondary hypernodes, based on the generated plurality of secondary time-stamped relations between the primary graphical dataset and the secondary graphical dataset. The plurality of secondary hypernodes may refer to changes analyzed between the primary graphical dataset and the secondary graphical datasets. For example, if multiple new entities representing similar products appear in consecutive secondary graphical datasets, and said new entities are linked by “introduced” or “related” relationships, the modification module 222 may generate a new “secondary hypernode” representing the “New Product Line”. In another example, if a group of entities representing products or services in a particular market segment show declining activity (such as, fewer new entities or decreasing relationships) over time, the modification module 222 may generate the secondary hypernode representing the “Declining Market Segment”.

After that, the modification module 222 may identify the plurality of primary entities comprising a plurality of predecessors associated with the plurality of primary hypernodes. The plurality of predecessors may correspond to a previous version of the primary graphical dataset. For instance, in the primary graphical dataset, the predecessors of the node may be identified from the in-coming edges of said node. For example, A, B and C may represent nodes as A->B->C. Herein, B is direct predecessor of C and A is distant predecessor of C. Essentially, the modification module 222 may trace the evolution of the plurality of primary entities by finding their corresponding entities in a previous version of the primary graphical dataset. Specifically, the modification module 222 may implement, but not limited to, entity matching, version control and graph traversal. The entity matching may include techniques such as fuzzy matching, probabilistic matching and machine learning. The fuzzy matching may include identifying variations, for instance, in entity names and attributes (for example, Levenshtein distance, Jaro-Winkler distance). The probabilistic matching may include utilizing probabilistic models to estimate the likelihood of two entities being the same based on their attributes and relationships. The machine learning may include training ML models (for example, supervised or unsupervised) to learn patterns and relationships between entities across different versions. Moreover, the version control may refer to maintaining a history of the primary graphical dataset with clear versioning information, thereby, enabling efficient retrieval and comparison of previous versions. The graph traversal may include traversing the graph structure to identify changes in entity connections, after the entities are matched across versions. The non-limiting examples of graph traversal technique may include depth-first search and breadth-first search, which may be used to efficiently navigate the graph and identify the relevant relationships.

Further, the modification module 222 may merge the plurality of primary hypernodes with the plurality of secondary hypernodes, based on the identified plurality of predecessors. Specifically, the modification module 222 may utilize the identified plurality of predecessors of primary entities to trace the evolution of the entities and their relationships back to earlier versions of the dataset. Based on the evolution information, the modification module 222 may identify the plurality of primary hypernodes which may evolved into or may be related to secondary hypernodes in the updated versions. For example, if the primary hypernode representing a “Product Line” in the primary graphical dataset has evolved into the secondary hypernode representing a “Refined Product Line” in a later version, the modification module 222 may identify said correspondence. If both primary and secondary hypernodes represent related but distinct concepts, the modification module 222 may integrate said primary and secondary hypernodes into a new, comprehensive hypernode which may capture the evolution of the entities. Moreover, the modification module 222 may updates the graph structure by merging, modifying, or creating new nodes to reflect the integrated hypernodes. Additionally, the modification module 222 may adjust the relationships between hypernodes and other entities in the graph to reflect the new integrated structure. Consequently, the modification module 222 may modify the generated plurality of primary entities of the primary graphical representation to generate the updated graphical representation, based on merging. Specifically, based on the secondary graphical representation generated by the modification module 222, as a result of modifications in the primary graphical representation, the modification module 222 may generate said updated graphical representation for the event.

The modification module 222 may identify a plurality of instances of the plurality of primary graphical representation, based on the modification of the generated plurality of primary entities of the primary graphical representation. Herein the plurality of instances may correspond to the plurality of primary graphical representation updated over a plurality of instances of time. The plurality of instances may refer to collection of different versions of the primary graphical representation which may been generated over time. Each instance may represent the state of the visualization at a specific point in time, represented by timestamps (for example, dates, times) or other temporal markers. The modification module 222, to identify said plurality of instances, may monitor and record, by utilizing version control systems (for example, Git) all modifications made to the plurality of primary entities over time. The modification module 222 may create a new instance of the primary graphical representation whenever changes are made to the plurality of primary entities, followed by associating each instance with the corresponding timestamp to indicate the time of the update.

Moreover, the modification module 222 may generate a plurality of instance relations between updated hypernodes, and updated entities, based on the identified plurality of instances. The plurality of instance relations may refer to connections or relationships between different instances identified plurality of instances, of the primary graphical representation. Each instance (the identified plurality of instances) may represent data of the graph at a specific point in time, thereby capturing the state of the entities and the relationships at that point of time. The instance relations may capture how said data may be related to each other, such as how entities have evolved, new relationships have emerged, or existing relationships have changed. Herein, the updated hypernodes may include primary hypernodes which may have been modified or updated based on the modifications in the secondary graphical datasets. Further, the updated entities may include primary entities which have undergone changes, such as attribute modifications, relationship changes, or the addition/deletion of entities. In an example, the instance relation may be “Evolved From”, which may imply that the secondary hypernode may have “evolved from” a specific primary hypernode in a previous instance. In another example, the instance relation may be “Merged With”, which may imply that two or more primary hypernodes may have been merged into a single secondary hypernode. Consequently, the modification module 222 may generate the updated graphical representation based on the generated plurality of instance relations between the updated hypernodes, and the updated entities. Specifically, the updated graphical representation may include new nodes for secondary hypernodes and updated existing nodes to reflect changes in properties and relationships. Moreover, the updated graphical representation may include new edges to represent the relationships between updated hypernodes and updated entities as defined by the instance relations. For example, if two primary hypernodes have been merged to form a single secondary hypernode, the modification module 222 may reflect said merger in the updated graphical representation by combining the corresponding nodes and the relationships.

Furthermore, once the updated graphical representation has been generated (by the modification module 222), the knowledge graph life cycle module 210 may output said updated graphical representation on the user interface 208 of the user device 102, 104. The user device may interchangeably be referred to as the computing device 102, 104. Specifically, the knowledge graph life cycle module 210 may utilize visualization library (for example, D3.js, Plotly, Bokeh) to output the updated graphical representation into as a visual format suitable for display on the user interface 208. The knowledge graph life cycle module 210 may include translating the updated graphical representation data (nodes, edges and attributes) into visual elements such as text, shapes, colors and positions. The visual elements may be then integrated into the user interface 208. The integration into the user interface 208 may include embedding the visualization within a web page using languages (for example Hypertext Markup Language (HTML), Cascading Style Sheets (CSS), JavaScript, or the like). The integration into the user interface 208 may further include displaying the visualization within a dedicated application window, followed by integrating the visualization with other UI elements, such as controls, menus, and interactive features.

In an aspect, the processor 204 may be configured to determine the Artificial-Intelligence (AI) based model for the primary graphical representation. The processor 204 may consider factors, including, but not limited to, AI model capabilities to determine the appropriate AI model. The appropriate AI model may be determined based on the specific requirements of the analysis task (for example, model size, computational resources, performance). Additionally, the determined appropriate AI model may possess capabilities such as natural language understanding (NLU), graph reasoning and text generation. The NLU may refer to interpreting user instructions and queries related to the graph. The graph reasoning may refer to reasoning about the relationships and structures within the graph. The text generation may refer to generate human-readable descriptions of the graph and the components. Further, the processor 204 may be configured to generate AI based model specific prompt for the determined appropriate AI model. The prompt may cause the AI model in analyzing the primary graphical representation and generating relevant recommendations. Further, the response corresponding to the generated AI based model specific prompt, may be generated. Herein, the response may include a plurality of recommendations for modifying the primary graphical representation. The plurality of recommendations may include, but not limited to, data enrichment, graph structure refinement and anomaly detection. The data enrichment may include recommending the inclusion of new data sources, attributes, or relationships to improve the completeness and accuracy of the primary graphical representation. The graph structure refinement may include recommending modifications to the graph structure, such as adding new nodes, edges, or hypernodes, or restructuring existing relationships. The anomaly detection may include identifying potential anomalies or inconsistencies in the data or the graph structure based on the analysis of external time-stamped relations. Furthermore, the plurality of recommendations may be generated based on analysis of primary graphical dataset and external time-stamped relations. For analysing the primary graphical dataset, the AI based model analyzes the existing structure and content of the primary graphical dataset, including, but not limited to, entity types and relationships, data quality and completeness and visualization quality.

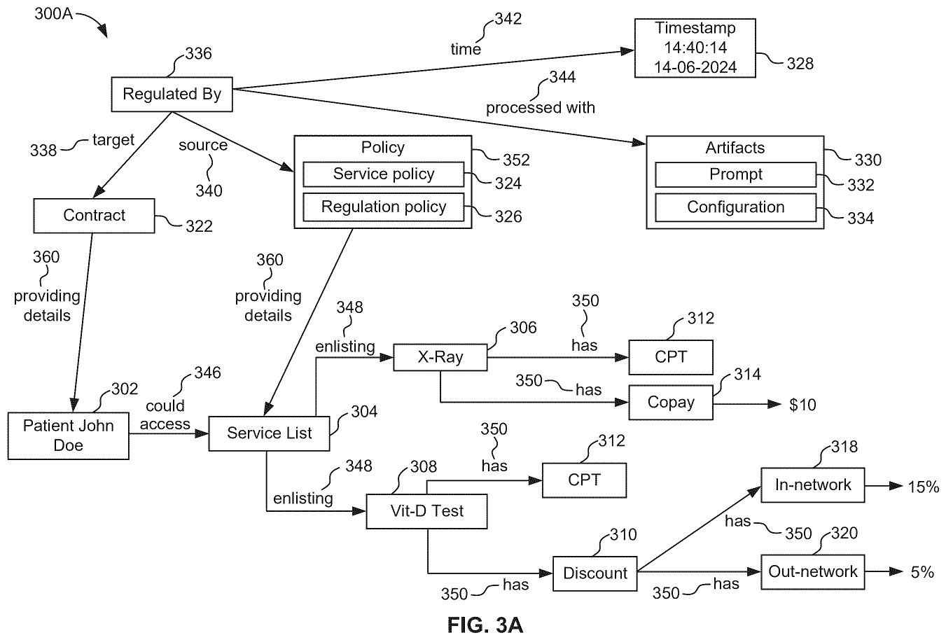

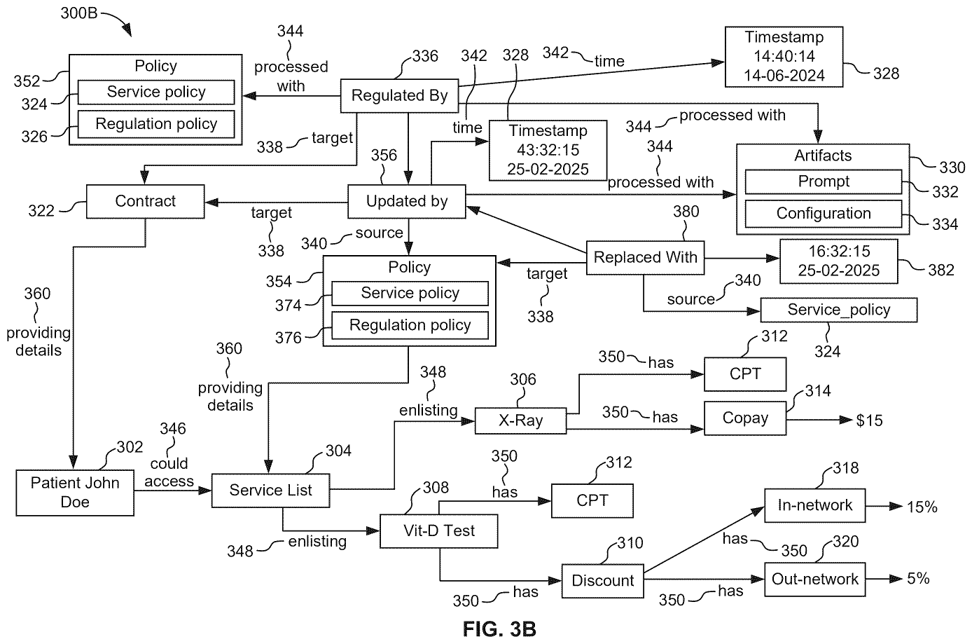

FIG. 3A-3B illustrates an exemplary implementation of provenance management of knowledge graph, in conjunction with FIG. 2. The FIG. 3A illustrates an example primary graphical representation 300 A and FIG. 3A illustrates an example primary graphical representation 300 B. In the example, as shown in FIG. 3A, a scenario may be considered where a patient “John Doe” get a X-ray service at a copay 314 of $10 per test and get 12% in network discount and 5% out network discount for a Vitamin D blood-test. The knowledge graph life cycle module 210 may receive primary graphical dataset corresponding to insurance policy of John Doe, from the data source 206 and generate primary graphical representation 300A for the received primary graphical dataset. The primary graphical representation 300A may include nodes, hypernodes and edges. The nodes may represent entities and events, for instance, patient John Doe 302, service list 304, X-Ray 306, Vitamin D Test 308, discount 310, CPT 312, copay 314, in-network 318, out-network 320, contract 322, regulated by 336 and timestamp 328. The hypernodes may include merging of multiple nodes, for instance, policy 352 (created by merging service policy 324 and regulation policy 326), artifacts 330 (created by merging nodes, prompt 332 and configuration 334). The edges may represent relationships between the nodes, for instance, target 338, source 340, time 342, processed with 344, could access 346, enlisting 348, has 350, providing details 36.

There is a contract 322 in between patient John Doe 302 and service provider. The service provider has its own policy 352 which govern the contract 322 between the service provider and service holder (that is John Dow 302). The policy 352 of John Dow 302 is processed by different artifacts 330. The contract 322, policy 352 of service provider, regulation policy 326, and artifacts 330 are components directly impacting the insurance policy of John Doe 302. Further, different events may trigger the modification/upgrade/delete of the contract 322, policy 352 of service provider, regulation policy 326, and artifacts 330. For example, there is an increase in amount of copay 314 of X-ray to $15, may lead to updation of policy 352 and service policy 324 (as shown in FIG. 3A). Now, based on said update the updated graphical representation 300B (as shown in FIG. 3B) may be generated. Specifically, when the copay 314 of X-ray increases to $15, policy 352 is updated, policy 354 may replaces policy 324. The event which captures the replacement of policy 352 by policy 354 may be the root-cause event which triggers the increment of copay 314 for X-ray to $15. Thereafter, the updated graphical representation 300B may be queried to get the response related to the mentioned event. For instance, user raises a query “When copay 314 of X-ray for John Doe is increased to $15”. The “updated by” 356 and “replaced with” 380 event nodes (as shown in FIG. 3B) may track the root cause. From said two event nodes, it may be observed that the policy 354 replaces policy 352 and, consequently, the copay 314 is increased to $15. The timestamps associated with the event nodes may depict the timeline of increment of copay 314.

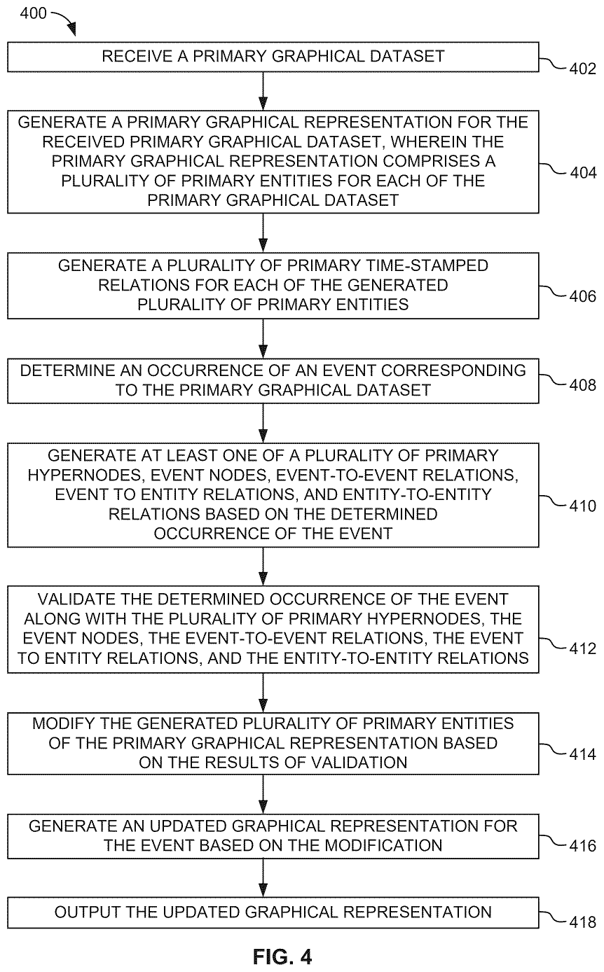

FIG. 4 illustrates the flow diagram of an example method 400 to implement provenance management of knowledge graph, in accordance with implementations of the present disclosure.

The method 400 may include receiving 402 the primary graphical dataset. Specifically, the primary graphical dataset may be received from plurality of data source 206. The primary graphical dataset may include the prompt, source documents and/or the plurality of artifacts.

The method 400 may include generating 404 the primary graphical representation for the received primary graphical dataset. The primary graphical representation may include the plurality of primary entities for each of the primary graphical dataset based on the primary unique identifier associated with the primary graphical dataset.

The method 400 may include generating 406 the plurality of primary time-stamped relations for each of the generated plurality of primary entities. Specifically, the generated plurality of primary entities may be correlated with similar pre-determined entities, to generate the plurality of primary time-stamped relations.

The method 400 may include determining 408 the occurrence of the event corresponding to the primary graphical dataset based on the generated plurality of primary time-stamped relations.

The method 400 may include generating 410 the plurality of primary hypernodes, event nodes, event-to-event relations, event to entity relations, and/or entity-to-entity relations based on the determined occurrence of the event.

The method 400 may include validating 412 the determined occurrence of the event along with the plurality of primary hypernodes, the event nodes, the event-to-event relations, the event to entity relations, and the entity-to-entity relations using Artificial-Intelligence based model.

The method 400 may include modifying 414 the generated plurality of primary entities of the primary graphical representation based on the results of validation.

The method 400 may include generating 416 the updated graphical representation for the event based on the modification.

The method 400 may include outputting 418 the updated graphical representation on a user interface 208 of the user device 102, 104.

Implementations of the present disclosure provides technical solutions to multiple technical problems that arise in the context of provenance management. For example, in the present disclosure, by incorporating timestamps into the relations, the time-stamped relations generation module 216 may allow for tracking the evolution of relationships over time and understanding the dynamics of the system. The time-stamped relationships enable historical analysis of how entities and their relationships have changed over time. The temporal information can be used to build predictive models that anticipate future changes and relationships.

Moreover, in the present disclosure, the generation of nodes and relationships may not be solely based on the occurrence of events, but also on the specific attributes associated with those events. By effectively utilizing these attributes, the back-end system 106 may create a more nuanced and informative graph representation that reflects the underlying complexities of the data.

By capturing instance relations (relationships between different versions of the KG), the modification module 222 may track changes at a much finer-grained level. Thus, the back-end system 106 rather than simply recording the timestamps of modifications, provides insights into how specific entities, relationships, and even hypernodes have evolved. Moreover, the captured instance relations may enable detailed historical analysis of the KG. User may investigate how the KG has changed over time, identify the causes of these changes, and understand the impact of these changes on the overall quality and reliability of the KG.

Further, AI-based validation may automate the quality control process, reducing the need for manual review and increasing efficiency. AI models can be continuously trained and refined as new data becomes available, leading to ongoing improvements in validation accuracy.

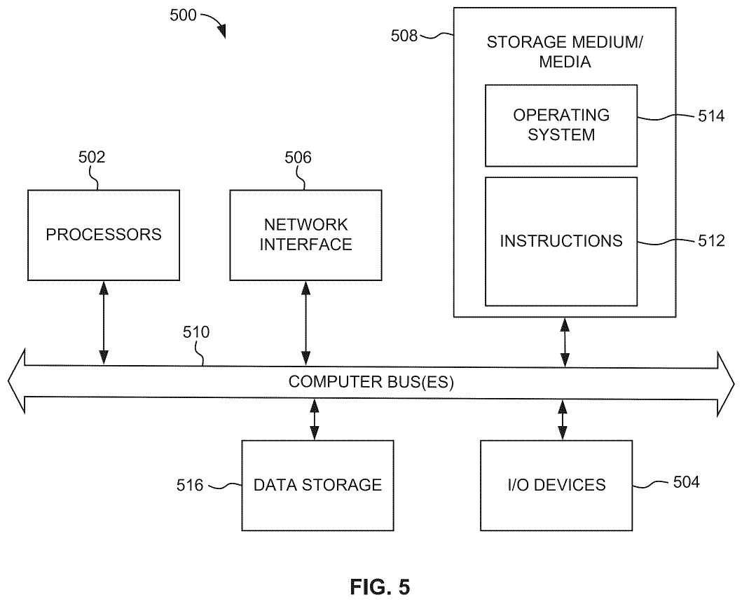

FIG. 5 illustrates a computer system 500 that may be used to implement the back-end system 106 for implementing provenance management of knowledge graph, in accordance with implementations of the present disclosure. More particularly, computing machines such as desktops, laptops, smartphones, tablets, and wearables which may be used to implement the tasks that may have the structure of the computer system 500. The computer system 500 may include additional components not shown and that some of the process components described may be removed and/or modified. In another example, a computer system 500 may be deployed on external-cloud platforms such as cloud, internal corporate cloud computing clusters, organizational computing resources, and/or the like.

The computer system 500 includes processor(s) 502, such as a central processing unit, ASIC or another type of processing circuit, input/output devices 504, such as a display, mouse keyboard, etc., a network interface 506, such as a Local Area Network (LAN), a wireless 502.11x LAN, a 3G or 4G mobile WAN or a WiMax WAN, and a computer-readable medium 508. Each of these components may be operatively coupled to a bus 510. The computer-readable medium 508 may be any suitable medium that participates in providing instructions to the processor(s) 502 for execution. For example, the computer-readable medium 508 may be non-transitory or non-volatile medium, such as a magnetic disk or solid-state non-volatile memory or volatile medium such as RAM. The instructions or modules stored on the computer-readable medium 508 may include machine-readable instructions 512 executed by the processor(s) 502 that cause the processor(s) 502 to perform the methods and functions of the system for provenance management of knowledge graph.

The system may be implemented as software stored on a non-transitory processor-readable medium and executed by the processors 502. For example, the computer-readable medium 508 may store an operating system 514, such as MAC OS, MS WINDOWS, UNIX, or LINUX, and code for the system. The operating system 514 may be multi-user, multiprocessing, multitasking, multithreading, real-time, and the like. For example, during runtime, the operating system 514 is running and the code for the system is executed by the processor(s) 502.

The computer system 500 may include a data storage 516, which may include non-volatile data storage. The data storage 516 stores any data used or generated by the system.

The network interface 506 connects the computer system 500 to internal systems for example, via a LAN. Also, the network interface 506 may connect the computer system 500 to the Internet. For example, the computer system 500 may connect to web browsers and other external applications and systems via the network interface 506.

What has been described and illustrated herein is an example along with some of its variations. The terms, descriptions, and figures used herein are set forth by way of illustration only and are not meant as limitations. Many variations are possible within the spirit and scope of the subject matter, which is intended to be defined by the following claims and their equivalents.

Implementations and all of the functional operations described in this specification may be realized in digital electronic circuitry, or in computer software, firmware, or hardware, including the structures disclosed in this specification and their structural equivalents, or in combinations of one or more of them. Implementations may be realized as one or more computer program products (i.e., one or more modules of computer program instructions encoded on a computer readable medium for execution by, or to control the operation of, data processing apparatus). The computer readable medium may be a machine-readable storage device, a machine-readable storage substrate, a memory device, a composition of matter effecting a machine-readable propagated signal, or a combination of one or more of them. The term computing system encompasses all apparatus, devices, and machines for processing data, including by way of example a programmable processor, a computer, or multiple processors or computers. The apparatus may include, in addition to hardware, code that creates an execution environment for the computer program in question (e.g., code that constitutes processor firmware, a protocol stack, a database management system, an operating system, or any appropriate combination of one or more thereof). A propagated signal is an artificially generated signal (e.g., a machine-generated electrical, optical, or electromagnetic signal) that is generated to encode information for transmission to suitable receiver apparatus.

A computer program (also known as a program, software, software application, script, or code) may be written in any appropriate form of programming language, including compiled or interpreted languages, and it may be deployed in any appropriate form, including as a stand-alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry (e.g., an FPGA (field programmable gate array) or an ASIC (application specific integrated circuit)).

Processors suitable for the execution of a computer program include, by way of example, both general and special purpose microprocessors, and any one or more processors of any appropriate kind of digital computer. Generally, a processor will receive instructions and data from a read only memory or a random-access memory or both. Elements of a computer can include a processor for performing instructions and one or more memory devices for storing instructions and data. Generally, a computer will also include or be operatively coupled to receive data from or transfer data to, or both, one or more mass storage devices for storing data (e.g., magnetic, magneto optical disks, or optical disks). However, a computer need not have such devices. Moreover, a computer may be embedded in another device (e.g., a mobile telephone, a personal digital assistant (PDA), a mobile audio player, a Global Positioning System (GPS) receiver). Computer readable media suitable for storing computer program instructions and data include all forms of non-volatile memory, media and memory devices, including by way of example semiconductor memory devices (e.g., EPROM, EEPROM, and flash memory devices); magnetic disks (e.g., internal hard disks or removable disks); magneto optical disks; and CD ROM and DVD-ROM disks. The processor and the memory may be supplemented by, or incorporated in, special purpose logic circuitry.

To provide for interaction with a user, implementations may be realized on a computer having a display device (e.g., a CRT (cathode ray tube), LCD (liquid crystal display) monitor) for displaying information to the user and a keyboard and a pointing device (e.g., a mouse, a trackball, a touchpad), by which the user may provide input to the computer. Other kinds of devices may be used to provide for interaction with a user as well; for example, feedback provided to the user may be any appropriate form of sensory feedback (e.g., visual feedback, auditory feedback, tactile feedback); and input from the user may be received in any appropriate form, including acoustic, speech, or tactile input.

Implementations may be realized in a computing system that includes a back end component (e.g., as a data server), a middleware component (e.g., an application server), and/or a front end component (e.g., a client computer having a graphical user interface or a Web browser, through which a user may interact with an implementation), or any appropriate combination of one or more such back end, middleware, or front end components. The components of the system may be interconnected by any appropriate form or medium of digital data communication (e.g., a communication network). Examples of communication networks include a local area network (LAN) and a wide area network (WAN), e.g., the Internet.

The computing system may include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

What is claimed is:

1. A system comprising:
a processor; and
a memory communicably coupled to the processor, wherein the memory comprises processor-executable instructions which, when executed by the processor, cause the processor to:
receive a primary graphical dataset from a plurality of data sources, wherein the primary graphical dataset comprises at least one of a prompt, source documents and a plurality of artifacts;
generate a primary graphical representation for the received primary graphical dataset, wherein the primary graphical representation comprises a plurality of primary entities for the primary graphical dataset based on a primary unique identifier associated with the primary graphical dataset;
generate a plurality of primary time-stamped relations for each of the generated plurality of primary entities by correlating the generated plurality of primary entities with similar pre-determined entities;
determine an occurrence of an event corresponding to the primary graphical dataset based on the generated plurality of primary time-stamped relations;
generate at least one of a plurality of primary hypernodes, event nodes, event-to-event relations, event to entity relations, and entity-to-entity relations based on the determined occurrence of the event;
validate the determined occurrence of the event along with the plurality of primary hypernodes, the event nodes, the event-to-event relations, the event to entity relations, and the entity-to-entity relations using an Artificial-Intelligence based model;
modify the generated plurality of primary entities of the primary graphical representation based on the results of validation;
generate an updated graphical representation for the event based on the modification; and
output the updated graphical representation on a user interface of a user device.

2. The system of claim 1, wherein to generate the primary graphical representation for the received primary graphical dataset, the processor is configured to:
extract a meta-data associated with the primary graphical dataset using a plurality of learning models, wherein the plurality of learning models comprise at least a Natural Language Processing (NLP) model;
generate a template comprising a plurality of attributes, based on the extracted meta-data, wherein the plurality of attributes comprise at least one of an unique identifier of an entity, a title of the entity, a type of the entity, a location of the entity, an owner of the entity, a source Uniform Resource Locator (URL) of the entity, a version number of the entity, and an inclusion time of the entity; and
generate the primary graphical representation for the received primary graphical dataset, based on the generated template.

3. The system of claim 2, wherein to generate the template comprising the plurality of attributes, the processor is configured to:
compare the extracted meta-data with a set of meta data pre-stored in a database, using the plurality of learning models;
determine a type of data associated with the primary graphical dataset, based on the comparison, wherein the specific type of data corresponds to a real-time meta-data comprising specific data properties;
create the primary unique identifier for each of the plurality of primary entities of the primary graphical dataset, based on the determined specific type of data; and
generate the template comprising the plurality of attributes, for the plurality of primary entities of the primary graphical dataset, based on the created primary unique identifier.

4. The system of claim 1, wherein to generate the plurality of primary time-stamped relations for each of the generated plurality of primary entities by correlating the generated plurality of primary entities with the similar pre-determined entities, the processor is configured to:
identify a time stamp data of the plurality of primary entities, based on a plurality of attributes;
determine a plurality of internal relations between the plurality of primary entities associated with the primary graphical dataset and the pre-determined entities, using the plurality of learning models, based on the identified time stamp data; and
generate the plurality of primary time-stamped relations for each of the generated plurality of primary entities, based on the determined plurality of internal relations.

5. The system of claim 1, wherein the processor is further configured to:
identify a time stamp data of a plurality of external entities, wherein the time stamp data of the plurality of external entities correspond to an inclusion time of the plurality of external entities;
determine a plurality of external relations between the plurality of primary entities associated with the primary graphical dataset, and the plurality of external entities, using the plurality of learning models, based on the identified time stamp data of the plurality of external entities, wherein the plurality of external entities correspond to target Knowledge Graphs (KG); and
generate a plurality of external time-stamped relations for each of the generated plurality of primary entities, based on the determined plurality of external relations.

6. The system of claim 1, wherein to generate the at least one of the plurality of primary hypernodes, the event nodes, the event to event relations, the event to entity relations, and the entity-to-entity relations based on the determined occurrence of the event, the processor is configured to:
determine the occurrence of the event by identifying a triggering operation of the event, wherein the triggering operation of the event comprises at least one of a modification of the primary graphical dataset, an upgrade of the primary graphical dataset, a deletion of the primary graphical dataset, a modification of the primary graphical dataset, and a modification of the plurality of artifacts;
determine a plurality of attributes associated with an event template, wherein the plurality of attributes comprise at least one of the triggering operation of the event, a successor identifier (ID) of the event, a predecessor ID of the event, an artifact list of the event, and a time of the event; and
generate the at least one of the plurality of primary hypernodes, the event nodes, the event-to-event relations, the event to entity relations, and the entity-to-entity relations based on the determined plurality of attributes associated with the event template.

7. The system of claim 1, wherein to modify the generated plurality of primary entities of the primary graphical representation based on the plurality of primary hypernodes, the event nodes, the event-to-event relations, the event to entity relations, and the entity-to-entity relations, the processor is configured to:
receive a secondary graphical dataset from the plurality of data sources, wherein the secondary graphical dataset correspond to an updated version of the primary graphical dataset;
generate a secondary graphical representation for the received secondary graphical dataset, wherein the secondary graphical representation comprises a plurality of secondary entities for each of the secondary graphical dataset based on a secondary unique identifier associated with the secondary graphical dataset; and
generate a plurality of secondary time-stamped relations between the primary graphical dataset and the secondary graphical datasets by correlating the generated plurality of primary entities with the generated plurality of secondary entities.

8. The system of claim 7, wherein to modify the generated plurality of primary entities of the primary graphical representation based on the plurality of primary hypernodes, the event nodes, the event-to-event relations, the event to entity relations, and the entity-to-entity relations, the processor is further configured to:
generate at least one of a plurality of secondary hypernodes, based on the generated plurality of secondary time-stamped relations between the primary graphical dataset and the secondary graphical dataset;
identify the plurality of primary entities comprising a plurality of predecessors associated with the at least one of the plurality of primary hypernodes, wherein the plurality of predecessors correspond to a previous version of the primary graphical dataset;
merge the at least one of the plurality of primary hypernodes with the plurality of secondary hypernodes, based on the identified plurality of predecessors; and
modify the generated plurality of primary entities of the primary graphical representation to generate the updated graphical representation, based on merging.

9. The system of claim 1, wherein to generate the updated graphical representation for the event based on the modification, the processor is configured to:
identify a plurality of instances of the plurality of primary graphical representation, based on the modification of the generated plurality of primary entities of the primary graphical representation, wherein the plurality of instances correspond to the plurality of primary graphical representation updated over a plurality of instances of time;
generate a plurality of instance relations between updated hypernodes, and updated entities, based on the identified plurality of instances; and
generate the updated graphical representation based on the generated plurality of instance relations between the updated hypernodes, and the updated entities.

10. The system of claim 6, wherein to determine the occurrence of the event by identifying the triggering operation of the event, the processor is configured to:
identify a root cause of the event, wherein the root cause of the event comprises at least one of the modification of the primary graphical dataset, the upgrade of the primary graphical dataset, the deletion of the primary graphical dataset, the modification of the primary graphical dataset, and the modification of the plurality of artifacts;
determine changes in the primary graphical dataset, based on the identified root cause event; and
determine the occurrence of the event, based on the determined changes.

11. The system of claim 1, wherein the processor is configured to:
determine the Artificial-Intelligence based model for the primary graphical representation;
generate at least one Artificial-Intelligence based model specific prompt for the determined Artificial-Intelligence based model; and
generate at least one response corresponding to the generated at least one prompt, wherein the at least one response comprises a plurality of recommendations for modifying the primary graphical representation.

12. A method comprising:
receiving, by a processor, a primary graphical dataset from a plurality of data sources, wherein the primary graphical dataset comprises at least one of a prompt, source documents and a plurality of artifacts;
generating, by the processor, a primary graphical representation for the received primary graphical dataset, wherein the primary graphical representation comprises a plurality of primary entities for the primary graphical dataset based on a primary unique identifier associated with the primary graphical dataset;
generating, by the processor, a plurality of primary time-stamped relations for each of the generated plurality of primary entities by correlating the generated plurality of primary entities with similar pre-determined entities;
determining, by the processor, an occurrence of an event corresponding to the primary graphical dataset based on the generated plurality of primary time-stamped relations;
generating, by the processor, at least one of a plurality of primary hypernodes, event nodes, event-to-event relations, event to entity relations, and entity-to-entity relations based on the determined occurrence of the event;
validating, by the processor, the determined occurrence of the event along with the plurality of primary hypernodes, the event nodes, the event-to-event relations, the event to entity relations, and the entity-to-entity relations using an Artificial-Intelligence based model;
modifying, by the processor, the generated plurality of primary entities of the primary graphical representation based on the results of validation;
generating, by the processor, an updated graphical representation for the event based on the modification; and
outputting, by the processor, the updated graphical representation on a user interface of a user device.

13. The method of claim 12, wherein generating the primary graphical representation for the received primary graphical dataset, comprises:
extracting, by the processor, a meta-data associated with the primary graphical dataset using a plurality of learning models, wherein the plurality of learning models comprise at least a Natural Language Processing (NLP) model;
generating, by the processor, a template comprising a plurality of attributes, based on the extracted meta-data, wherein the plurality of attributes comprise at least one of an unique identifier of an entity, a title of the entity, a type of the entity, a location of the entity, an owner of the entity, a source Uniform Resource Locator (URL) of the entity, a version number of the entity, and an inclusion time of the entity; and
generating, by the processor, the primary graphical representation for the received primary graphical dataset, based on the generated template.

14. The method of claim 13, wherein generating the template comprising the plurality of attributes, comprises:
comparing, by the processor, the extracted meta-data with a set of meta data pre-stored in a database, using the plurality of learning models;
determining, by the processor, a type of data associated with the primary graphical dataset, based on the comparison, wherein the specific type of data corresponds to the real-time meta-data comprising specific data properties;
creating, by the processor, the primary unique identifier for each of the plurality of primary entities of the primary graphical dataset, based on the determined specific type of data; and
generating, by the processor, the template comprising the plurality of attributes, for the plurality of primary entities of the primary graphical dataset, based on the created primary unique identifier.

15. The method of claim 12, wherein generating the plurality of primary time-stamped relations for each of the generated plurality of primary entities by correlating the generated plurality of primary entities with the similar pre-determined entities, comprises:
identifying, by the processor, a time stamp data of the plurality of primary entities, based on a plurality of attributes;
determining, by the processor, a plurality of internal relations between the plurality of primary entities associated with the primary graphical dataset and the pre-determined entities, using the plurality of learning models, based on the identified time stamp data; and
generating, by the processor, the plurality of primary time-stamped relations for each of the generated plurality of primary entities, based on the determined plurality of internal relations.

16. The method of claim 12, further comprising:
identifying, by the processor, a time stamp data of a plurality of external entities, wherein the time stamp data of the plurality of external entities correspond to an inclusion time of the plurality of external entities;
determining, by the processor, a plurality of external relations between the plurality of primary entities associated with the primary graphical dataset, and the plurality of external entities, using the plurality of learning models, based on the identified time stamp data of the plurality of external entities, wherein the plurality of external entities correspond to a target Knowledge Graphs (KG); and
generating, by the processor, a plurality of external time-stamped relations for each of the generated plurality of primary entities, based on the determined plurality of external relations.

17. The method of claim 12, wherein generating the at least one of the plurality of primary hypernodes, the event nodes, the event-to-event relations, the event to entity relations, and the entity-to-entity relations based on the determined occurrence of the event, comprises:
determining, by the processor, the occurrence of the event by identifying a triggering operation of the event, wherein the triggering operation of the event comprises at least one of a modification of the primary graphical dataset, an upgrade of the primary graphical dataset, a deletion of the primary graphical dataset, a modification of the primary graphical dataset, and a modification of the plurality of artifacts;
determining, by the processor, a plurality of attributes associated with an event template, wherein the plurality of attributes comprise at least one of the triggering operation of the event, a successor identifier (ID) of the event, a predecessor ID of the event, an artifact list of the event, and a time of the event; and
generating, by the processor, the at least one of the plurality of primary hypernodes, the event nodes, the event-to-event relations, the event to entity relations, and the entity-to-entity relations based on the determined plurality of attributes associated with the event template.

18. The method of claim 12, wherein modifying the generated plurality of primary entities of the primary graphical representation based on the plurality of primary hypernodes, the event nodes, the event-to-event relations, the event to entity relations, and the entity-to-entity relations, comprises:
receiving, by the processor, a secondary graphical dataset from the plurality of data sources, wherein the secondary graphical dataset corresponds to an updated version of the primary graphical dataset;
generating, by the processor, a secondary graphical representation for the received secondary graphical dataset, wherein the secondary graphical representation comprises a plurality of secondary entities for each of the secondary graphical dataset based on a secondary unique identifier associated with the secondary graphical dataset; and
generating, by the processor, a plurality of secondary time-stamped relations between the primary graphical dataset and the secondary graphical datasets by correlating the generated plurality of primary entities with the generated plurality of secondary entities.

19. The method of claim 12, wherein generating the updated graphical representation for the event based on the modification, comprises:
identifying, by the processor, a plurality of instances of the plurality of primary graphical representation, based on the modification of the generated plurality of primary entities of the primary graphical representation, wherein the plurality of instances correspond to the plurality of primary graphical representation updated over a plurality of instances of time;
generating, by the processor, a plurality of instance relations between updated hypernodes, and updated entities, based on the identified plurality of instances; and
generating, by the processor, the updated graphical representation based on the generated plurality of instance relations between the updated hypernodes, and the updated entities.

20. A non-transitory computer readable medium comprising a processor-executable instructions that cause a processor to:
receive a primary graphical dataset from a plurality of data sources, wherein the primary graphical dataset comprises at least one of a prompt, source documents and a plurality of artifacts;
generate a primary graphical representation for the received primary graphical dataset, wherein the primary graphical representation comprises a plurality of primary entities for the primary graphical dataset based on a primary unique identifier associated with the primary graphical dataset;
generate a plurality of primary time-stamped relations for each of the generated plurality of primary entities by correlating the generated plurality of primary entities with similar pre-determined entities;
determine an occurrence of an event corresponding to the primary graphical dataset based on the generated plurality of primary time-stamped relations;
generate at least one of a plurality of primary hypernodes, event nodes, event-to-event relations, event to entity relations, and entity-to-entity relations based on the determined occurrence of the event;
validate the determined occurrence of the event along with the plurality of primary hypernodes, the event nodes, the event-to-event relations, the event to entity relations, and the entity-to-entity relations using an Artificial-Intelligence based model;
modify the generated plurality of primary entities of the primary graphical representation based on the results of validation;
generate an updated graphical representation for the event based on the modification; and
output the updated graphical representation on a user interface of a user device.
